(19) United States
(12) Patent Application Publication
(10) Pub. No.: US 2026/0093266 A1
(43) Pub. Date: Apr. 2, 2026

(54) ELECTRONIC DEVICE FOR EXPLORATION PATH PLANNING OF UNMANNED AERIAL VEHICLE AND OPERATING METHOD OF ELECTRONIC DEVICE

(71) Applicant: Electronics and Telecommunications Research Institute, Daejeon (KR)

(72) Inventors: Youkyung HONG, Daejeon (KR); Youngsun KWON, Daejeon (KR); Suseong KIM, Daejeon (KR); Sanghyouk CHOI, Daejeon (KR)

(21) Appl. No.: 19/015,495

(22) Filed: Jan. 9, 2025

(30) Foreign Application Priority Data
Sep. 30, 2024 (KR) 10-2024-0132642

(51) Int. Cl. G05D 1/648; G01C 21/20; G05D 1/644; G05D 105/80; G05D 107/20; G05D 109/20; G08G 5/57

(52) U.S. Cl. CPC G05D 1/6484; G01C 21/20; G05D 1/644; G08G 5/57; G05D 2105/87; G05D 2107/22; G05D 2109/20

(57) ABSTRACT

Disclosed is an electronic device which includes a position estimation unit that estimates position information of an unmanned aerial vehicle based on at least some of a plurality of sensing information received from the unmanned aerial vehicle, an environment mapping unit that generates mapping information based on remaining some of the plurality of sensing information, and an exploration path planning unit that generates a path graph based on the position information and the mapping information, explores a plurality of paths based on the path graph, calculates exploration gains for the candidate paths based on a distance from an obstacle and a past flight path, and determines an optimal exploration path based on the calculated exploration gains.

### CROSS-REFERENCE TO RELATED APPLICATIONS

This application claims priority under 35 U.S.C. § 119 to Korean Patent Application No. 10-2024-0132642 filed on Sep. 30, 2024, in the Korean Intellectual Property Office, the disclosures of which are incorporated by reference herein in their entireties.

### BACKGROUND

Embodiments of the present disclosure described herein relate to an electronic device for planning an exploration path of an unmanned aerial vehicle for searching for a missing person in a forest environment, and more particularly, relate to an electronic device for planning an efficient exploration path based on a distance from an obstacle and a past flight path in a forest environment.

Unmanned aerial vehicles (UAVs) may perform time-consuming, complex, and dangerous tasks instead of humans. Accordingly, the use of UAVs is increasing in various application fields such as intelligent agriculture, search, rescue, security, and advanced natural disaster surveillance. However, it is still difficult to achieve complete autonomy in UAV operation, and the intervention of skilled human pilots is required due to safety issues.

Meanwhile, sampling-based exploration path planning methods using the UAVs have been developed mainly in underground environments such as mines or caves. In these underground environments, there are no obstacles other than an outer wall, and there is a single open space. In other words, there is no distinction between narrow and wide spaces in the underground environment. In contrast, in the case of forest environments, there may be multiple open spaces since obstacles such as trees, bushes, and rocks of various sizes are scattered. Therefore, there is an issue that it is difficult to apply exploration path planning methods in underground environments to forest environments.

### SUMMARY

Embodiments of the present disclosure provide an electronic device and a method of operating the electronic device for planning an exploration path of an unmanned aerial vehicle that fully autonomously explores an unknown 3D space, to increase the possibility of survival of a missing person in a forest environment.

According to an embodiment of the present disclosure, an electronic device includes a position estimation unit that estimates position information of an unmanned aerial vehicle based on at least some of a plurality of sensing information received from the unmanned aerial vehicle, an environment mapping unit that generates mapping information based on remaining some of the plurality of sensing information, and an exploration path planning unit that generates a path graph based on the position information and the mapping information, explores a plurality of paths based on the path graph, calculates exploration gains for the candidate paths based on a distance from an obstacle and a past flight path, and determines an optimal exploration path based on the calculated exploration gains.

According to an embodiment, the exploration path planning unit may impose a penalty on the exploration gains based on the distance from the obstacle.

According to an embodiment, the exploration path planning unit may impose the penalty on the exploration gains based on the past flight path.

According to an embodiment, the exploration path planning unit may determine a path with a greatest exploration gain among the candidate paths as the optimal exploration path.

According to an embodiment, the mapping information may be classified into an occupied space, an unoccupied space, and an unknown space. The environment mapping unit may generate the mapping information by mapping each of voxels included in the remaining some to one of the occupied space, the unoccupied space, and the unknown space.

According to an embodiment, the path graph may include nodes and edges on the unoccupied space. The exploration path planning unit may explore the plurality of paths based on the nodes and the edges using a shortest path exploration algorithm.

According to an embodiment, the at least some of the plurality of sensing information may include first sensing information and second sensing information, and the position information may include 3D coordinate information and 3D attitude information of the unmanned aerial vehicle, wherein the position estimation unit may estimate the 3D coordinate information based on the first sensing information, and may estimate the 3D attitude information based on the second sensing information.

According to an embodiment, the 3D attitude information may include at least one of roll information, pitch information, and yaw information with respect to the unmanned aerial vehicle.

According to an embodiment, the exploration path planning unit may generate a plurality of waypoints at which the unmanned aerial vehicle may fly based on the optimal exploration path.

According to an embodiment, the plurality of waypoints may correspond to nodes of the optimal exploration path, respectively.

According to an embodiment, the electronic device may further include a trajectory generation unit that generates a flight trajectory by connecting the plurality of waypoints.

According to an embodiment, the electronic device may further include a flight control unit that generates a flight control command for controlling the unmanned aerial vehicle to follow the flight trajectory.

According to an embodiment of the present disclosure, a method of operating an electronic device for planning an exploration path of an unmanned aerial vehicle, includes receiving a plurality of sensing information from the unmanned aerial vehicle, estimating position information of the unmanned aerial vehicle based on at least some of the plurality of sensing information, generating mapping information based on remaining some of the plurality of sensing information, generating a path graph based on the position information and the mapping information, exploring a plurality of paths based on the path graph, calculating exploration gains with respect to the candidate paths, and determining an optimal exploration path based on the exploration gains.

According to an embodiment, the calculating of the exploration gains with respect to the candidate paths may include imposing a penalty on the exploration gains based on a distance from an obstacle.

According to an embodiment, the calculating of the exploration gains with respect to the candidate paths may include imposing a penalty on the exploration gains based on a past flight path of the unmanned aerial vehicle.

According to an embodiment, the mapping information may be classified into an occupied space, an unoccupied space, and an unknown space, and the generating of the mapping information based on the remaining some of the plurality of sensing information may include mapping each of voxels included in the remaining some to one of the occupied space, the unoccupied space, and the unknown space.

According to an embodiment, the generating of the path graph based on the position information and the mapping information may include generating a plurality of nodes by performing a random sampling within a exloration radius of the unmanned aerial vehicle, deleting a node existing in the occupied space among the plurality of nodes, generating a plurality of edges by connecting the remaining nodes among the plurality of nodes, and deleting an edge passing through the occupied space among the plurality of edges.

According to an embodiment, the at least some of the plurality of sensing information may include first sensing information and second sensing information, and the estimating of the position information of the unmanned aerial vehicle based on at least some of the plurality of sensing information may include estimating 3D coordinate information with respect to the unmanned aerial vehicle, based on the first sensing information, and estimating 3D attitude information with respect to the unmanned aerial vehicle, based on the second sensing information.

According to an embodiment, the 3D attitude information may further include at least one of roll information, pitch information, and yaw information with respect to the unmanned aerial vehicle.

According to an embodiment, the method may further include generating a flight trajectory based on the optimal exploration path, and generating a flight control command for controlling the unmanned aerial vehicle based on the flight trajectory.

### BRIEF DESCRIPTION OF THE FIGURES

The above and other objects and features of the present disclosure will become apparent by describing in detail embodiments thereof with reference to the accompanying drawings.

FIG. 1 illustrates an autonomous flight system of an unmanned aerial vehicle, according to an embodiment of the present disclosure.

FIG. 2 illustrates an electronic device, according to an embodiment of the present disclosure.

FIG. 3 illustrates an operating method of an electronic device, according to an embodiment of the present disclosure.

FIG. 4 illustrates an operating method of an electronic device for generating a path graph, according to an embodiment of the present disclosure.

FIG. 5 illustrates an example of a path graph, according to an embodiment of the present disclosure.

FIG. 6 illustrates an example of an operation of an electronic device for calculating an exploration gain, according to an embodiment of the present disclosure.

FIGS. 7A to 7C illustrate examples of an operation of an electronic device for calculating an exploration gain, according to an embodiment of the present disclosure.

FIGS. 8A and 8B illustrate simulation results for a flight path of an unmanned aerial vehicle.

FIG. 9 illustrates an electronic device, according to an embodiment of the present disclosure.

### DETAILED DESCRIPTION

Hereinafter, embodiments of the present disclosure may be described in detail and clearly to such an extent that an ordinary one in the art easily implements the present disclosure.

Components that are described in the detailed description with reference to the terms “unit”, “module”, “block”, “˜er or ˜or”, etc. and function blocks illustrated in drawings will be implemented with software, hardware, or a combination thereof. For example, the software may be a machine code, firmware, an embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof.

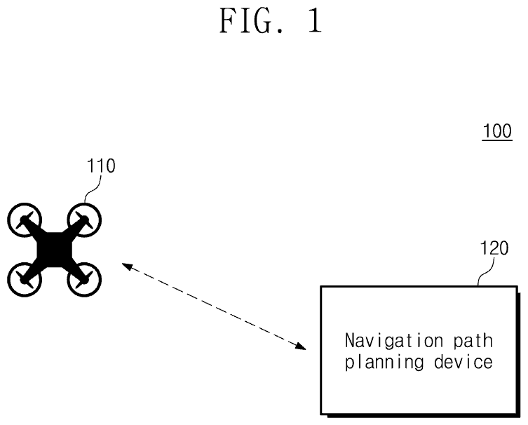

FIG. 1 illustrates an autonomous flight system of an unmanned aerial vehicle, according to an embodiment of the present disclosure. Referring to FIG. 1, an autonomous flight system 100 may include an unmanned aerial vehicle 110 and an exploration path planning device 120.

The unmanned aerial vehicle 110 may perform autonomous flight to search for a missing person in a forest environment. For example, the unmanned aerial vehicle 110 may perform autonomous flight in a forest environment under the control of the exploration path planning device 120.

The unmanned aerial vehicle 110 may include a plurality of sensors. For example, the unmanned aerial vehicle 110 may include a GPS (global positioning system) sensor, an IMU (inertial measurement unit) sensor, and a LiDAR (light detection and ranging) sensor. However, the scope of the present disclosure is not limited thereto, and the unmanned aerial vehicle 110 may include various sensors.

The unmanned aerial vehicle 110 may obtain sensing information using a plurality of sensors. For example, the unmanned aerial vehicle 110 may obtain first sensing information using a GPS sensor. The first sensing information may be related to the position of the unmanned aerial vehicle 110. For example, the unmanned aerial vehicle 110 may obtain second sensing information using an IMU sensor. The second sensing information may be related to the acceleration and angular velocity of the unmanned aerial vehicle 110. For example, the unmanned aerial vehicle 110 may obtain third sensing information using a LiDAR sensor. The third sensing information may represent environmental information searched through the LiDAR sensor. The environmental information may include information about the position of an obstacle existing within the exloration radius of the unmanned aerial vehicle 110, the distance to the obstacle, etc. In an embodiment, the third sensing information may be composed of a plurality of voxels in a three-dimensional (3D) space. That is, the third sensing information may include the plurality of voxels in the 3D space.

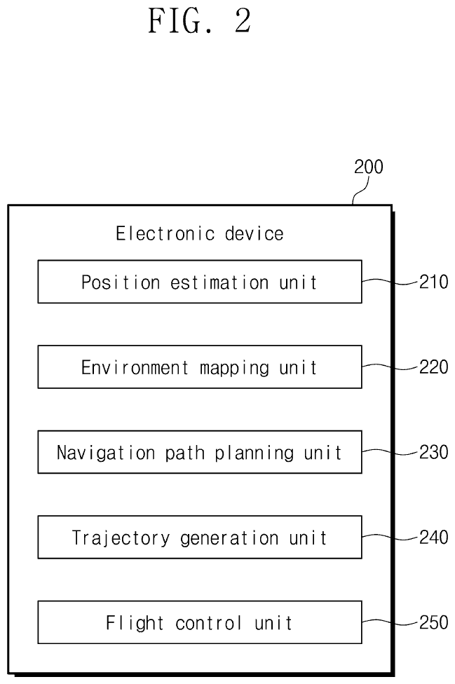

The exploration path planning device 120 may receive sensing information from the unmanned aerial vehicle 110. The exploration path planning device 120 may determine an optimal exploration path with the greatest exploration gain based on the received sensing information. An operation of the exploration path planning device 120 will be described in more detail with reference to FIGS. 2 to 4.

The exploration path planning device 120 may generate a flight control command for controlling the unmanned aerial vehicle 110. For example, the exploration path planning device 120 may generate a flight control command based on the optimal exploration path. The exploration path planning device 120 may transmit the flight control command to the unmanned aerial vehicle 110.

In an embodiment, the exploration path planning device 120 may receive information on a past flight path from the unmanned aerial vehicle 110.

In an embodiment, the exploration path planning device 120 may obtain information on a past flight path of the unmanned aerial vehicle 110 based on the first sensing information and the second sensing information received from the unmanned aerial vehicle 110.

In an embodiment, the unmanned aerial vehicle 110 and the exploration path planning device 120 may transmit and receive information using remote communication. The unmanned aerial vehicle 110 and the exploration path planning device 120 may transmit and receive information by performing wired communication or wireless communication. For example, the unmanned aerial vehicle 110 and the exploration path planning device 120 may communicate through at least one of various communication forms such as Ethernet, Wi-Fi, LTE, 5G mobile communication, etc.

As described above, the unmanned aerial vehicle 110 may fly an exploration path that is far from an obstacle, based on the flight control command of the exploration path planning device 120. In addition, the unmanned aerial vehicle 110 may fly an exploration path that does not overlap with a past flight path based on the flight control command of the exploration path planning device 120.

FIG. 2 illustrates an electronic device, according to an embodiment of the present disclosure. An electronic device 200 of FIG. 2 may correspond to the exploration path planning device 120 of FIG. 1. Referring to FIGS. 1 and 2, the electronic device 200 may include a position estimation unit 210, an environment mapping unit 220, an exploration path planning unit 230, a trajectory generation unit 240, and a flight control unit 250.

The position estimation unit 210 may estimate position information of the unmanned aerial vehicle 110. The position information may include 3D coordinate information and 3D attitude information of the unmanned aerial vehicle 110.

For example, the position estimation unit 210 may estimate 3D coordinate information indicating coordinates in 3D space of the unmanned aerial vehicle 110 based on first sensing information received from the unmanned aerial vehicle 110.

For example, the position estimation unit 210 may estimate 3D attitude information indicating the attitude of the unmanned aerial vehicle 110 in 3D space based on the second sensing information received from the unmanned aerial vehicle 110. In an embodiment, the 3D attitude information may include at least one of roll information, pitch information, and yaw information.

The environment mapping unit 220 may generate mapping information by mapping the third sensing information received from the unmanned aerial vehicle 110. The mapping information may be divided into three states: an occupied space, an unoccupied space, and an unknown space. The occupied space may correspond to a space where an obstacle exists among the spaces searched by the unmanned aerial vehicle 110, the unoccupied space may correspond to a space where an obstacle does not exist among the spaces searched by the unmanned aerial vehicle 110, and the unknown space may correspond to a space that is not searched by the unmanned aerial vehicle 110.

For example, the environment mapping unit 220 may generate mapping information by mapping a plurality of voxels configuring the third sensing information to an occupied space, an unoccupied space, and an unknown space. In other words, the environment mapping unit 220 may map each of the plurality of voxels configuring the third sensing information to one of the occupied space, the unoccupied space, and the unknown space.

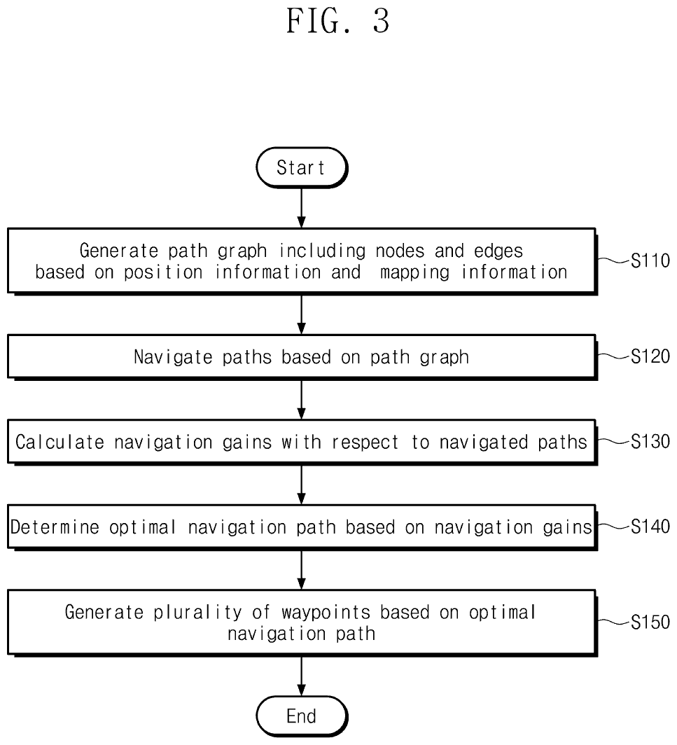

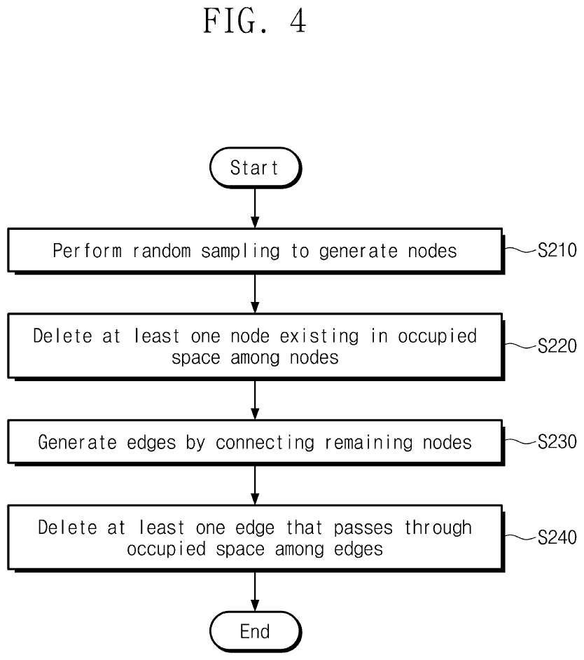

The exploration path planning unit 230 may determine an optimal exploration path with the greatest exploration gain based on the position information and the mapping information. The exploration path planning unit 230 may generate a plurality of waypoints along which the unmanned aerial vehicle 110 may fly based on the optimal exploration path. The operation of the exploration path planning unit 230 will be described in more detail with reference to FIGS. 3 and 4.

The trajectory generation unit 240 may generate a flight trajectory based on the plurality of waypoints. For example, the trajectory generation unit 240 may generate a smooth flight trajectory on which the unmanned aerial vehicle 110 may fly by connecting the plurality of waypoints.

The flight control unit 250 may generate a flight control command based on the flight trajectory. The flight control unit 250 may transmit the flight control command to the unmanned aerial vehicle 110. The unmanned aerial vehicle 110 may follow the flight trajectory based on the flight control command.

FIG. 3 illustrates an operating method of an electronic device, according to an embodiment of the present disclosure. Referring to FIGS. 1 to 3, in operation S110, the exploration path planning unit 230 of the electronic device 200 may generate a path graph including nodes and edges based on the position information and the mapping information. For example, the exploration path planning unit 230 of the electronic device 200 may generate nodes and edges on an unoccupied space within a exloration radius. The path graph generation operation of the exploration path planning unit 230 will be described in more detail with reference to FIG. 4.

In operation S120, the exploration path planning unit 230 of the electronic device 200 may explore a plurality of paths based on the path graph. For example, the exploration path planning unit 230 of the electronic device 200 may explore paths between outer nodes positioned at the end of the path graph and a root node corresponding to the position of the unmanned aerial vehicle 110 using a shortest path exploration algorithm such as a Dijkstra.

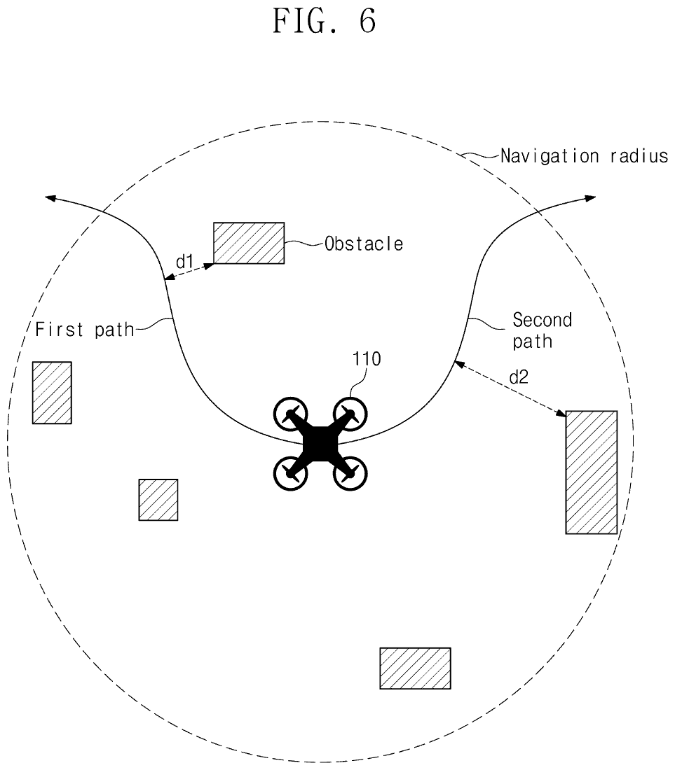

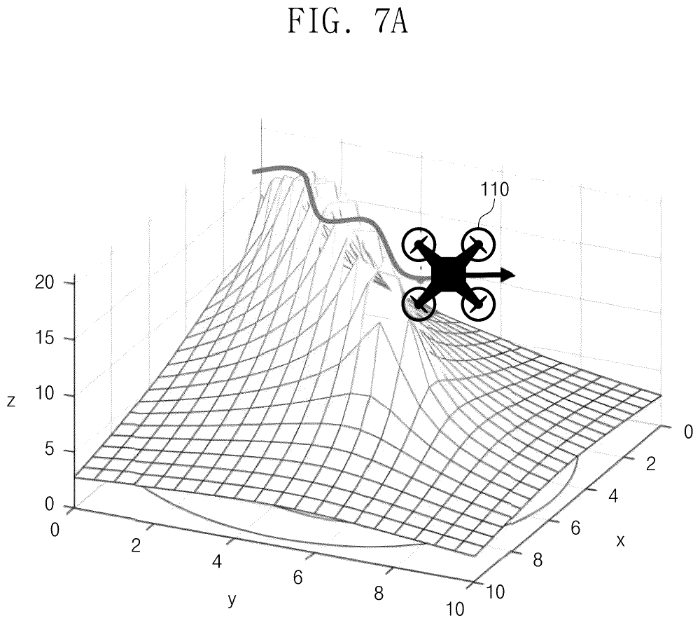

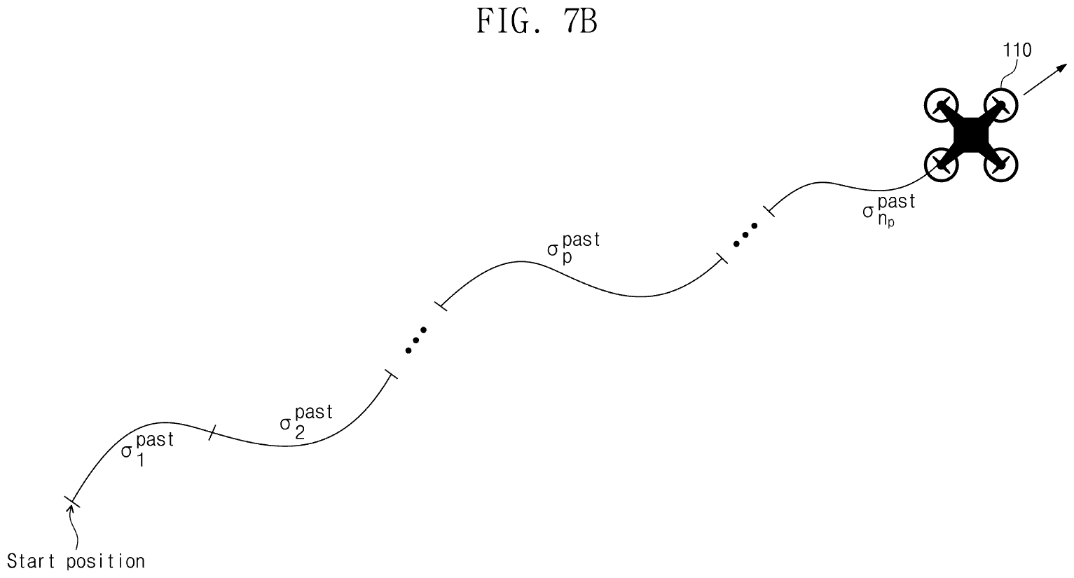

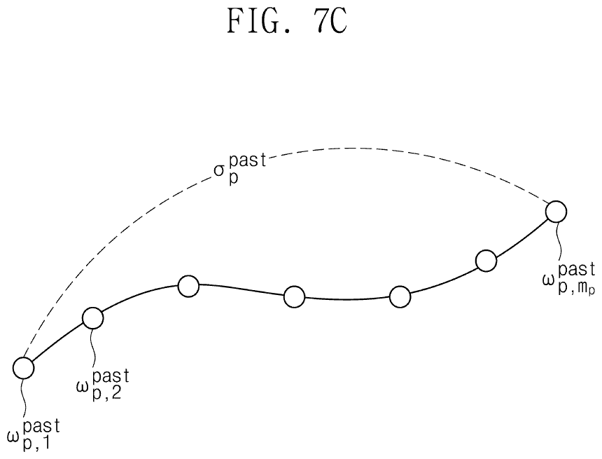

In operation S130, the exploration path planning unit 230 of the electronic device 200 may calculate exploration gains with respect to the candidate paths. For example, the exploration path planning unit 230 of the electronic device 200 may calculate exploration gains for each of the candidate paths based on the distance to the obstacle and the past flight path. The exploration gain calculation operation of the exploration path planning unit 230 will be described in more detail with reference to FIGS. 6 to 7C.

In operation S140, the exploration path planning unit 230 of the electronic device 200 may determine an optimal exploration path based on the exploration gains. For example, the exploration path planning unit 230 of the electronic device 200 may select a path with the largest exploration gain among the candidate paths as the optimal exploration path.

In operation S150, the exploration path planning unit 230 of the electronic device 200 may generate a plurality of waypoints on which the unmanned aerial vehicle 110 may fly based on the optimal exploration path. In an embodiment, the plurality of waypoints may each correspond to nodes existing on the optimal exploration path.

FIG. 4 illustrates an operating method of an electronic device for generating a path graph, according to an embodiment of the present disclosure. In FIG. 4, operations S210 to S240 may correspond to operation S110 of FIG. 3.

Referring to FIGS. 2 to 4, in operation S210, the exploration path planning unit 230 of the electronic device 200 may perform random sampling within a exloration radius to generate nodes. For example, the exploration path planning unit 230 of the electronic device 200 may perform random sampling within an occupied space and an unoccupied space included in the mapping information to generate the nodes.

In operation S220, the exploration path planning unit 230 of the electronic device 200 may delete at least one node existing in the occupied space among the nodes. For example, the exploration path planning unit 230 of the electronic device 200 may determine whether the generated nodes exist in the occupied space. The exploration path planning unit 230 of the electronic device 200 may delete at least one node that is determined to exist in the occupied space. In an embodiment, the exploration path planning unit 230 of the electronic device 200 may delete nodes that overlap at least a portion of the occupied space.

In operation S230, the exploration path planning unit 230 of the electronic device 200 may generate edges by connecting the remaining nodes that are not deleted. In detail, the exploration path planning unit 230 of the electronic device 200 may generate edges by connecting nodes that exist in the unoccupied space.

In operation S240, the exploration path planning unit 230 of the electronic device 200 may delete at least one edge that passes through the occupied space among the generated edges. For example, the exploration path planning unit 230 of the electronic device 200 may determine whether the generated edges pass through the occupied space. The exploration path planning unit 230 of the electronic device 200 may delete at least one edge that is determined to pass through the occupied space. In an embodiment, the exploration path planning unit 230 of the electronic device 200 may delete an edge that passes through at least a portion of the occupied space.

As described above, the exploration path planning unit 230 of the electronic device 200 may generate a path graph by performing operations S210 to S240.

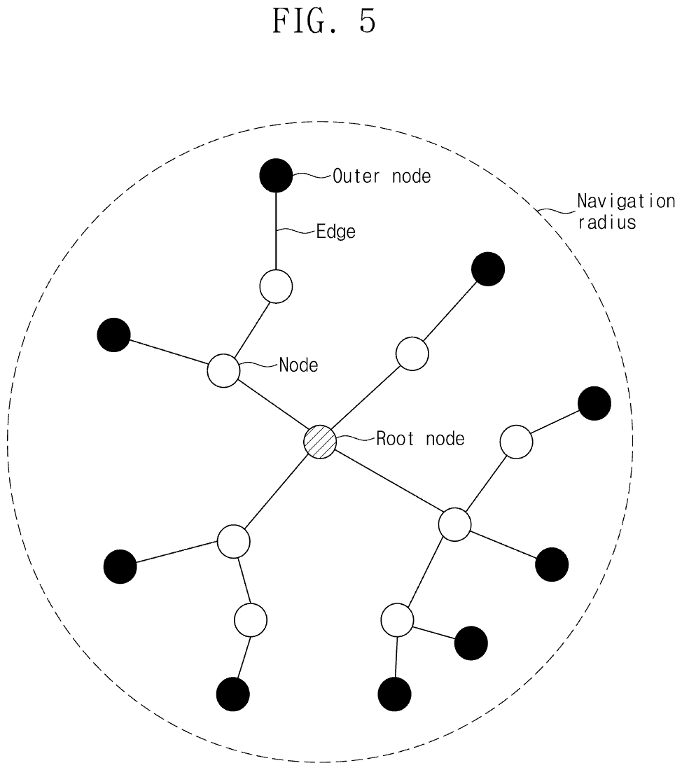

FIG. 5 illustrates an example of a path graph, according to an embodiment of the present disclosure. Referring to FIGS. 2 to 5, the path graph may include nodes and edges existing on the unoccupied space. The nodes may include a root node, a plurality of nodes, and a plurality of outer nodes. The root node may indicate the current position of the unmanned aerial vehicle 110. The outer node may indicate a node positioned at the end of the path graph.

FIG. 6 illustrates an example of an operation of an electronic device for calculating an exploration gain, according to an embodiment of the present disclosure.

Referring to FIGS. 2, 3, and 6, the exploration path planning unit 230 of the electronic device 200 may calculate exploration gains for candidate paths based on the distance from an obstacle. For example, the exploration path planning unit 230 of the electronic device 200 may calculate exploration gains corresponding to each of the candidate paths based on the following Equation 1.

$$ExplorationGain ( {σ}_{i} ) = {e}^{- {γ}_{S} S ( {σ}_{i} , {σ}_{exp} )} {\sum }_{j = 1}^{{m}_{i}} VolumetricGain ( {ω}_{i , j} ) {e}^{- {γ}_{D} D ( {ω}_{i , 1} , {ω}_{i , j} )} {e}^{- {γ}_{O} \frac{1}{O ( {ω}_{i , j} )}} \qquad [ Equation 1 ]$$

In this case, represents σᵢ an i-th path (where “i” is a natural number), ExplorationGain(σᵢ) represents the exploration gain for the path σᵢ, mᵢ represents the number of nodes on the path σᵢ, ω_{i,j} represents a j-th node positioned on the path σᵢ, γ_{S} and γ_{D} represent weights greater than “0”, respectively, D(ω_{i,1}, ω_{i,j}) represents the distance from node ω_{i,1} to node ω_{i,j} (where “j” is a natural number), S(σᵢ, σₑₓₚ) represents the similarity between the straight path σₑₓₚ and the path σᵢ that matches the current travel direction of the unmanned aerial vehicle 110, VolumetricGain(ω_{i,j}) represents the size of the space in which the unknown space may be changed into the occupied space or the unoccupied space when the unmanned aerial vehicle 110 is positioned at node ω_{i,j}, O(ω_{i,j}) represents the distance between the node ω_{i,j} and the closest obstacle to the node ω_{i,j}, and γ_{O} may represent the weight for O(ω_{i,j}). In an embodiment, to determine, O(ω_{i,j}), the exploration path planning unit 230 of the electronic device 200 may configure information on the occupied space as a “k”-dimensional tree, and then may query and return the closest distance from node ω_{i,j}.

As in Equation 1, the exploration path planning unit 230 of the electronic device 200 may impose a penalty on the exploration gain as the distance to the obstacle is closer by using the inverse of O(ω_{i,j}). Therefore, the exploration path planning unit 230 of the electronic device 200 may plan the exploration path of the unmanned aerial vehicle 110 in a forest environment where there are multiple open spaces and many irregular obstacles such as trees and bushes.

Referring to FIG. 6 again, it may be seen that a distance d1 between the first path and the obstacle is shorter than a distance d2 between the second path and the obstacle. In detail, it may be seen that the first path is closer to the obstacle than the second path. Therefore, the first path may incur a greater penalty on the exploration gain than the second path.

FIGS. 7A to 7C illustrate examples of an operation of an electronic device for calculating an exploration gain, according to an embodiment of the present disclosure. Referring to FIGS. 1 to 3 and FIGS. 7A to 7C, FIG. 7A illustrates the unmanned aerial vehicle 110 exploring in a 3D space, FIG. 7B illustrates past flight paths

$${σ}_{1}^{past} to {σ}_{{n}_{p}}^{past}$$

according to FIG. 7A, and FIG. 7C illustrates any past flight path

$${σ}_{p}^{past}$$

among the past flight paths

$${σ}_{1}^{past} to {σ}_{{n}_{p}}^{past}$$

### of FIG. 7B.

The exploration path planning unit 230 of the electronic device 200 may calculate exploration gains for the candidate paths based on the past flight paths

$${σ}_{1}^{past} to {σ}_{{n}_{p}}^{past}$$

of the unmanned aerial vehicle 110. For example, the exploration path planning unit 230 of the electronic device 200 may calculate exploration gains for the candidate paths based on Equation 2 below.

$$ExplorationGain ( {σ}_{i} ) = {e}^{- {γ}_{P} P ( {σ}_{i} )} {e}^{- {γ}_{S} S ( {σ}_{i} , {σ}_{exp} )} {\sum }_{j = 1}^{{m}_{i}} VolumetricGain ( {ω}_{i , j} ) {e}^{- {γ}_{D} D ( {ω}_{i , 1} , {ω}_{i , j} )} {e}^{- {γ}_{O} \frac{1}{O ( {ω}_{i , j} )}} \qquad [ Equation 2 ]$$

In this case, P(σᵢ) may represent a potential field function for the path σᵢ, and γ_{P} may represent a weight for P(σᵢ). In detail, unlike Equation 1, Equation 2 may further utilize a potential field function as a variable.

The exploration path planning unit 230 of the electronic device 200 may calculate a potential field function P(σᵢ) for the path σᵢ based on Equation 3 below.

$$P ( {σ}_{i} ) = {\sum }_{j = 1}^{{m}_{i}} {\sum }_{p = 1}^{{n}_{p}} {( 1 - ρ )}^{( {n}_{p} - p )} {\sum }_{q = 1}^{{m}_{p}} \frac{1}{‖ {ω}_{i , j} - {ω}_{p , q}^{past} ‖} \qquad [ Equation 3 ]$$

In this case, nₚ represents the number of past flight paths, mₚ represents the number of nodes on an arbitrary past flight path

$${σ}_{p}^{past} , {σ}_{p , q}^{past}$$

represents a q-th node positioned on an arbitrary past flight path

$${σ}_{p}^{past} ,$$

and ρ may represent a decay factor that weakens a repulsive force generated by the past flight path as the exploration progresses. In an embodiment, the potential field function may be defined as a repulsive force. However, the scope of the present disclosure is not limited thereto, and the potential field function may be defined as the sum of an attractive force and the repulsive force.

As in Equations 2 and 3, the exploration path planning unit 230 of the electronic device 200 may impose a penalty on the exploration gain by using the potential field function as the exploration path overlaps with the past flight path. Therefore, the exploration path planning unit 230 of the electronic device 200 may determine an optimal exploration path that minimizes the overlap with the past flight path. That is, the exploration path planning unit 230 of the electronic device 200 may shorten the flight time required to complete the exploration by minimizing overlapping paths.

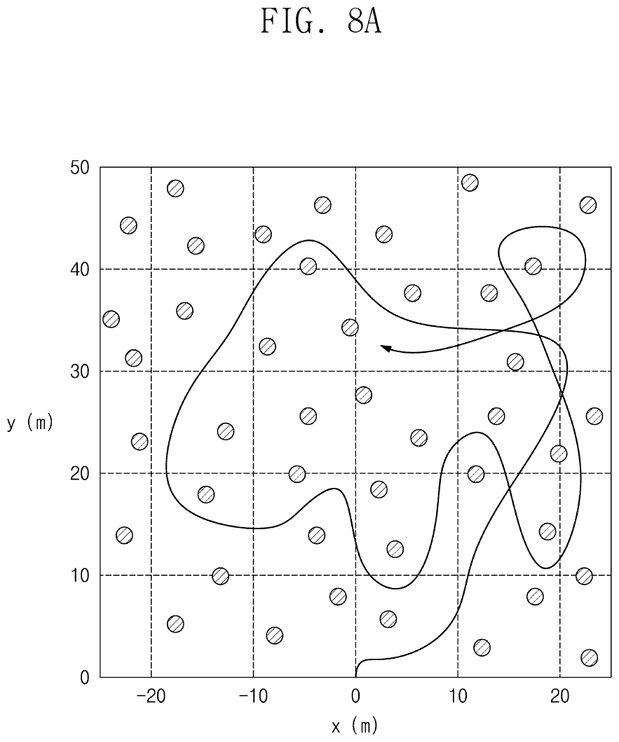

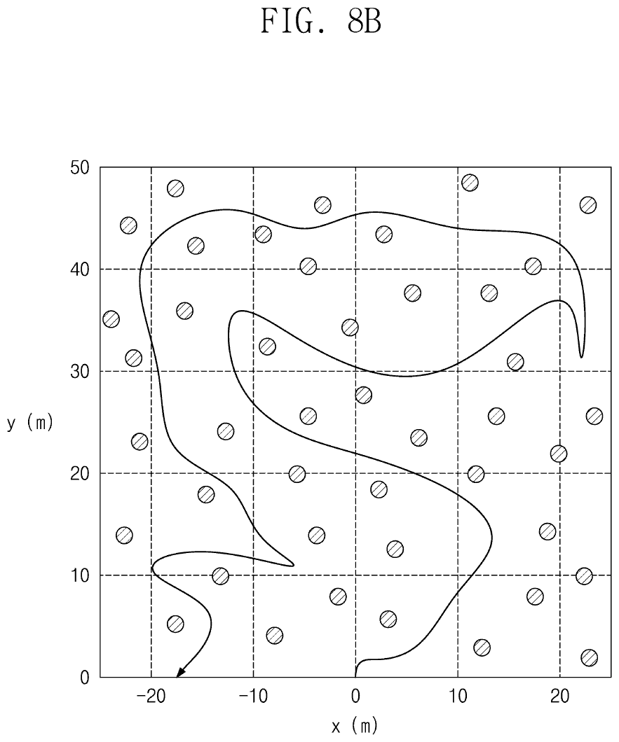

FIGS. 8A and 8B illustrate simulation results for a flight path of an unmanned aerial vehicle.

In FIGS. 8A and 8B, the simulation is performed using a Gazebo, which is a virtual physics simulator based on an ROS (robot operating system). The simulation is performed in an environment where cylindrical obstacles are randomly placed in a finite space of ‘50 m (length)×50 m (width)×5 m (height)’ size. Each obstacle may correspond to a tree. In this case, it is assumed that the radius of each obstacle is ‘0.25 m’, the height of each obstacle is ‘5 m’, and the placement density of the obstacles is ‘0.1 tree/m²’. In FIGS. 8A and 8B, each obstacle (e.g., point cloud data detected as an obstacle) is expressed as a point indicated by a hatching. The simulation is performed using a LiDAR sensor model that generates ‘180×40’ samples every ‘10 Hz’. In this case, the LiDAR sensor model has a field of view of 360 degrees and 80 degrees in the horizontal and vertical planes, respectively. The simulation is performed using a 3DR Iris quadcopter model as an unmanned aerial vehicle model. The flight control of the unmanned aerial vehicle model is implemented based on an open source PX4 firmware v1.9.0. A MAVROS interface is used for path planning and flight control of the simulator.

In FIGS. 8A and 8B, it is assumed that the unmanned aerial vehicle starts from an origin and flies until it explores all the space.

FIG. 8A is a simulation result to which a general exploration path planning method is applied. In FIG. 8A, the flight time and flight distance taken for the exploration are ‘194.72 seconds’ and ‘312.48 m’, respectively.

FIG. 8B is a simulation result to which an exploration path planning method according to an embodiment of the present disclosure is applied. In FIG. 8B, the flight time and flight distance taken for the exploration are ‘168.00 seconds’ and ‘272.87 m’, respectively.

As illustrated in FIG. 8A and FIG. 8B, it may be seen that the exploration path planning method according to an embodiment of the present disclosure has the effect of generating a safe path by preventing the distance from an obstacle from becoming close. In addition, it may be seen that the exploration path planning method according to an embodiment of the present disclosure has the effect of shortening the flight time by minimizing the overlap with the past flight path.

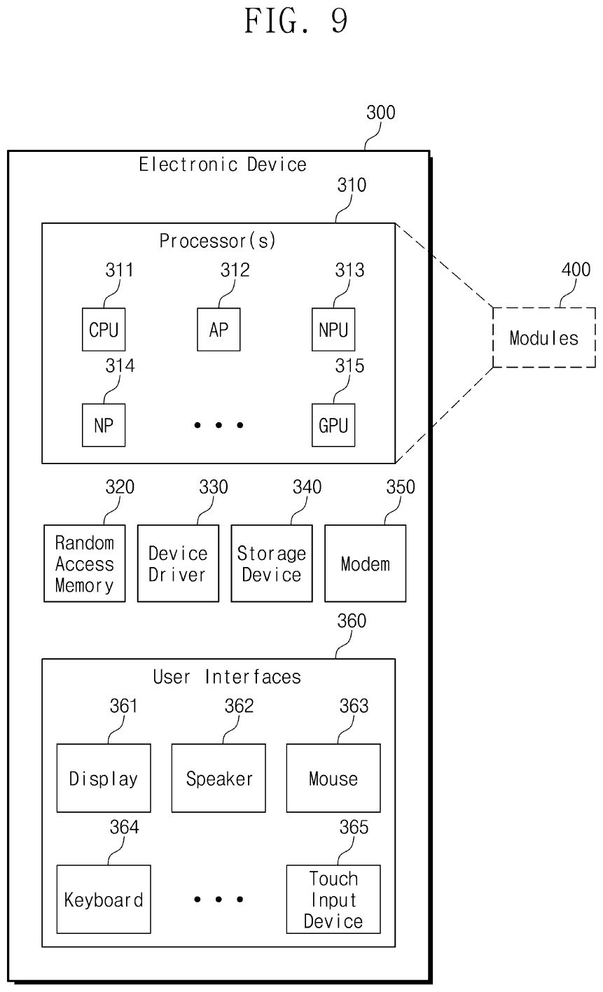

FIG. 9 illustrates an electronic device, according to an embodiment of the present disclosure. Referring to FIG. 9, an electronic device 300 may be configured to plan an exploration path of an unmanned aerial vehicle. The electronic device 300 may include processors 310, a random access memory 320, a device driver 330, a storage device 340, a MODEM 350, and user interfaces 360.

The processors 310 may include at least one general-purpose processor, such as, for example, a central processing unit (CPU) 311, an application processor (AP) 312, etc. The processors 310 may also include at least one special purpose processor, such as a neural processing unit 313, a neuromorphic processor 314, a graphics processing unit (GPU) 315, etc. The processors 310 may include two or more homogeneous processors.

At least one of the processors 310 may execute modules 400. For example, at least some of the modules 400 may be modules that are trained based on machine learning or deep learning, and at least other some of the modules 400 may be modules that operate based on a predetermined algorithm.

At least one of the processors 310 may be used to train the modules 400 (e.g., some of the modules 400 that are related to learning) or to execute the trained modules 400. The at least one of the processors 310 may learn or execute the modules 400 based on various data or information. For example, the modules 400 may be implemented in the form of commands (or codes) that are executed by at least one of the processors 310. In this case, at least one processor may load commands (or codes) of the modules 400 into the random access memory 320.

As another example, at least one (or at least the other) processor of the processors 310 may be manufactured to implement the modules 400. For example, at least one processor may be a dedicated processor implemented in hardware based on the modules 400 generated by training the modules 400.

As another example, at least one (or at least the other) of the processors 310 may be manufactured to implement various machine learning modules or various deep learning modules. The at least one processor may implement the modules 400 by receiving information (e.g., commands or codes) corresponding to the modules 400.

The random access memory 320 may be used as a working memory of the processors 310 and may be used as a main memory or a system memory of the electronic device 300. The random access memory 320 may include a volatile memory such as a dynamic random access memory or a static random access memory or a nonvolatile memory such as a phase-change random access memory, a ferroelectric random access memory, a magnetic random access memory, or a resistive random access memory.

The device driver 330 may control the following peripheral devices depending on a request of the processors 310: the storage device 340, the MODEM 350, and the user interfaces 360. The storage device 340 may include a stationary storage device such as a hard disk drive or a solid state drive, or a removable storage device such as an external hard disk drive, an external solid state drive, or a removable memory card.

The MODEM 350 may provide remote communication with an external device (e.g., the unmanned aerial vehicle 110 of FIG. 1). The MODEM 350 may perform wired or wireless communication with the external device. The MODEM 350 may communicate with the external device based on at least one of various communication schemes such as Ethernet, wireless-fidelity (Wi-Fi), long term evolution (LTE), and 5th generation (5G) mobile communication.

The user interfaces 360 may receive information from a user and may provide information to the user. The user interfaces 360 may include at least one user output interface such as a display 361 or a speaker 362, and at least one user input interface such as a mouse 363, a keyboard 364, or a touch input device 165.

Commands (or codes) of the modules 400 may be received through the MODEM 350 and stored in the storage device 340. The commands (or codes) of the modules 400 may be stored in a removable storage device and coupled to the electronic device 300. The commands (or codes) of the modules 400 may be loaded from the storage device 340 into the random access memory 320 and may be executed.

In an embodiment, the modules 400 may perform operations for planning an exploration path as described with reference to FIGS. 2 to 7C. For example, the modules 400 may include a position estimation module, an environment mapping module, an exploration path planning module, a trajectory generation module, and a flight control module. The position estimation module, the environment mapping module, the exploration path planning module, the trajectory generation module, and the flight control module may correspond to the position estimation unit 210, the environment mapping unit 220, the exploration path planning unit 230, the trajectory generation unit 240, and the flight control unit 250 of FIG. 2, respectively.

In the above embodiments, components according to the present disclosure are described by using the terms “first”, “second”, “third”, and the like. However, the terms “first”, “second”, “third”, and the like may be used to distinguish components from each other and do not limit the present disclosure. For example, the terms “first”, “second”, “third”, and the like do not involve an order or a numerical meaning of any form.

According to an embodiment of the present disclosure, the electronic device may generate a flight path for completely exploring an unknown 3D space without a help of a pilot by supplementing and improving a sampling-based exploration path planning method.

According to an embodiment of the present disclosure, the electronic device may generate a flight path with improved stability in a forest environment with mixed obstacles.

According to an embodiment of the present disclosure, the electronic device may generate a flight path with improved efficiency by generating a new path that does not overlap with a past flight path. Therefore, unmanned aerial vehicles may quickly complete a missing person exploration mission.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure.

What is claimed is:

1. An electronic device comprising:
a position estimation unit configured to estimate position information of an unmanned aerial vehicle based on at least some of a plurality of sensing information received from the unmanned aerial vehicle;
an environment mapping unit configured to generate mapping information based on remaining some of the plurality of sensing information; and
an exploration path planning unit configured to generate a path graph based on the position information and the mapping information, to explore a plurality of paths based on the path graph, to calculate exploration gains for the candidate paths based on a distance from an obstacle and a past flight path, and to determine an optimal exploration path based on the calculated exploration gains.

2. The electronic device of claim 1, wherein the exploration path planning unit imposes a penalty on the exploration gains based on the distance from the obstacle.

3. The electronic device of claim 2, wherein the exploration path planning unit imposes the penalty on the exploration gains based on the past flight path.

4. The electronic device of claim 3, wherein the exploration path planning unit determines a path with a greatest exploration gain among the candidate paths as the optimal exploration path.

5. The electronic device of claim 1, wherein the mapping information is classified into an occupied space, an unoccupied space, and an unknown space, and
wherein the environment mapping unit generates the mapping information by mapping each of voxels included in the remaining some to one of the occupied space, the unoccupied space, and the unknown space.

6. The electronic device of claim 5, wherein the path graph includes nodes and edges on the unoccupied space, and
wherein the exploration path planning unit explores the plurality of paths based on the nodes and the edges using a shortest path exploration algorithm.

7. The electronic device of claim 1, wherein the at least some of the plurality of sensing information includes first sensing information and second sensing information,
wherein the position information includes 3D coordinate information and 3D attitude information of the unmanned aerial vehicle, and
wherein the position estimation unit:
estimates the 3D coordinate information based on the first sensing information; and
estimates the 3D attitude information based on the second sensing information.

8. The electronic device of claim 7, wherein the 3D attitude information includes at least one of roll information, pitch information, and yaw information with respect to the unmanned aerial vehicle.

9. The electronic device of claim 1, wherein the exploration path planning unit generates a plurality of waypoints at which the unmanned aerial vehicle may fly based on the optimal exploration path.

10. The electronic device of claim 9, wherein the plurality of waypoints correspond to nodes of the optimal exploration path, respectively.

11. The electronic device of claim 10, further comprising:
a trajectory generation unit configured to generate a flight trajectory by connecting the plurality of waypoints.

12. The electronic device of claim 11, further comprising:
a flight control unit configured to generate a flight control command for controlling the unmanned aerial vehicle to follow the flight trajectory.

13. A method of operating an electronic device for planning an exploration path of an unmanned aerial vehicle, the method comprising:
receiving a plurality of sensing information from the unmanned aerial vehicle;
estimating position information of the unmanned aerial vehicle based on at least some of the plurality of sensing information;
generating mapping information based on remaining some of the plurality of sensing information;
generating a path graph based on the position information and the mapping information;
exploring a plurality of paths based on the path graph;
calculating exploration gains with respect to the candidate paths; and
determining an optimal exploration path based on the exploration gains.

14. The method of claim 13, wherein the calculating of the exploration gains with respect to the candidate paths includes imposing a penalty on the exploration gains based on a distance from an obstacle.

15. The method of claim 14, wherein the calculating of the exploration gains with respect to the candidate paths includes imposing a penalty on the exploration gains based on a past flight path of the unmanned aerial vehicle.

16. The method of claim 13, wherein the mapping information is classified into an occupied space, an unoccupied space, and an unknown space, and
wherein the generating of th mapping information based on the remaining some of the plurality of sensing information includes mapping each of voxels included in the remaining some to one of the occupied space, the unoccupied space, and the unknown space.

17. The method of claim 16, wherein the generating of the path graph based on the position information and the mapping information includes:
generating a plurality of nodes by performing a random sampling within a exloration radius of the unmanned aerial vehicle;
deleting a node existing in the occupied space among the plurality of nodes;
generating a plurality of edges by connecting the remaining nodes among the plurality of nodes; and
deleting an edge passing through the occupied space among the plurality of edges.

18. The method of claim 13, wherein the at least some of the plurality of sensing information includes first sensing information and second sensing information, and
wherein the estimating of the position information of the unmanned aerial vehicle based on at least some of the plurality of sensing information includes:
estimating 3D coordinate information with respect to the unmanned aerial vehicle, based on the first sensing information; and
estimating 3D attitude information with respect to the unmanned aerial vehicle, based on the second sensing information.

19. The method of claim 18, wherein the 3D attitude information includes at least one of roll information, pitch information, and yaw information with respect to the unmanned aerial vehicle.

20. The method of claim 13, further comprising:
generating a flight trajectory based on the optimal exploration path; and
generating a flight control command for controlling the unmanned aerial vehicle based on the flight trajectory.
